(19) United States
(12) Patent Application Publication
(10) Pub. No.: US 2008/0130899 A1
(43) Pub. Date: Jun. 5, 2008

(54) Access authentication system, access authentication method, and program storing medium storing programs thereof

(75) Inventors: Eiji Iwamoto, Fukuoka-shi (JP); Akio Yonehara, Fukuoka-shi (JP); Takashi Ikeda, Fukuoka-shi (JP); Akinori Kubota, Fukuoka-shi (JP)

Correspondence Address: GREER, BURNS & CRAIN, 300 S WACKER DR, 25TH FLOOR, CHICAGO, IL, 60606, US

(73) Assignee: Fujitsu Limited, Kawasaki-shi (JP)

(21) Appl. No.: 11/982,599

(22) Filed: Nov. 2, 2007

(30) Foreign Application Priority Data
Dec. 4, 2006 (JP) 2006-327032

(51) Int. Cl. H04L 9/08

(52) U.S. Cl. 380/278

(57) ABSTRACT

When a decryption-key request is transmitted from a client computer to a management server via a network apparatus, the network apparatus instead of the client computer adds location information to the decryption-key request. When the decryption-key request reaches the management server, location information stored therein is compared with location information associated with the decryption-key request. When the two pieces of the location information are the same, a decryption key is transmitted to the client computer. Thus, only when the management server receives the decryption-key request via the network apparatus which adds the specific location information to the decryption-key request, the management server transmits the decryption key to the client computer. This allows the encrypted data to be accessed within a specific area.

### BACKGROUND OF THE INVENTION

1. Field of the Invention

The present invention relates to a system for authenticating access to information, such as files, stored in storage devices, such as magnetic storage devices (hard disks), in information terminals, such as personal computers (PCs).

In particular, the present invention relates to a file access authentication system that allows secret information, which is strictly protected from information leakage, to be accessed only in a specific area.

2. Description of the Related Art

In recent years, measures for ensuring security of secret information handled in corporate activities have been important issues. In particular, the leakage of information stored in personal computers (PCs) has been major concerns.

Typical business organizations take, for example, the following security measures:

access restriction using an entry/exit management system (e.g., passwords are required during entry to areas (e.g., buildings, floors, and rooms) where secret information is handled).

Security measures for accessing important secret information (files) stored in the hard disks of PCs employ the following schemes:

access restriction based on user authentication during login on the PCs;

access restriction by setting passwords for data files for reading and/or writing; and

access restriction by encrypting data files and setting passwords for decrypting the data files.

Current problems of information leakage are as follows. Secret information has conventionally been mainly used in places (security areas) where security measures, such as entry/exit control, are implemented, whereas carrying (taking out) equipment, such as PCs, containing secret information during business trip has become common due to the advancement of miniaturization of the equipment. As a result, the theft and loss in transit show no sign of decreasing.

The miniaturization of the equipment makes it easier to take out secret information without being noticed by anyone, thus making it difficult to prevent a malicious user from taking out the information.

In addition, even with a PC and secret information for which security measures using an ID, password, and so on, are implemented, the measures may be insufficient, the password may be easily guessed by a third person, or the password may be cracked. Thus, the risk of occurrence of information leakage is very high.

In order to solve such problems, several authentication methods for enhancing the security are disclosed. Japanese Unexamined Patent Application Publication No. 11-328118 discloses a method in which multiple password items are displayed at random to prompt a user to enter passwords corresponding thereto. Japanese Unexamined Patent Application Publication No. 2005-39868 discloses a method in which a chat client computer issues a request for a channel secret key to a key management server. The key management server transmits the secret key to the chat client computer via the chat server, while the secret key is encrypted with a public key received from the chat client computer.

In either of the known authentication systems, the user side (i.e., the user or the equipment) has ID/password information, which serves as a key for authentication, and such systems are based on a premise that there are no malicious users (i.e., they do not leak the secret information).

Accordingly, if the user intentionally takes out secret information or a malicious third person obtains an ID and a password by some kind of method, he or she can access the secret information. Thus, the known authentication system cannot prevent taking out of encrypted files and PCs and also cannot prevent subsequent information leakage.

### SUMMARY OF THE INVENTION

In view of such situations, an object of the present invention is to provide an information leakage prevention technology that does not require authentication key (an ID/password) that an individual user enters during authentication of access to secret information and that prevents, even if secret information leaks out, access to the information by restricting file access to within a specific area.

One aspect of the present invention provides an access authentication system which includes: a client computer which transmits a decryption-key request which requests for a decryption key which enables decryption of an encrypted file; a network apparatus which adds to the decryption-key request first authentication information which is used for authenticating the decryption-key request, and transfers the decryption-key request; and a management server which authenticates the decryption-key request on the basis of the first authentication information, and transmits the decryption key to the client computer upon successful authentication of the decryption-key request.

In the access authentication system, the first authentication information preferably includes location information indicating a location of the network apparatus.

The client computer may add second authentication information which is used for authenticating the decryption-key request to the decryption-key request. In this configuration, the management server authenticates the decryption-key request on the basis of the first authentication information and the second authentication information.

In the access authentication system, the second authentication information may include user information indicating a user of the client computer.

In the access authentication system, the second authentication information may include attribute information indicating an attribute of the encrypted file.

The management server may authenticate the decryption-key request on the basis of the first authentication information and a time when the management server has received the decryption-key request.

The client computer preferably communicates with the network apparatus at a data link layer so as to transmit the decryption-key request with a broadcast address as a destination address thereof.

Another aspect of the present invention provides an access authentication method which is executed by an access authentication system which includes a network apparatus. The access authentication system authenticates a decryption-key request which is transmitted from a client computer. The decryption-key request requests for a decryption key which enables decryption of an encrypted file. The access authentication method includes the steps of: receiving the decryption-key request; adding to the decryption-key request first authentication information which is used for authenticating the decryption-key request; transferring the decryption-key request; authenticating the decryption-key request on the basis of the first authentication information; and transmitting the decryption key upon successful authentication of the decryption-key request.

Yet another aspect of the present invention provides a program storage medium which is readable by a computer. The program storage medium stores programs of instructions for a first computer and a second computer for executing an access authentication method. The first computer authenticates a decryption-key request which is transmitted from a client computer. The decryption-key request requests for a decryption key which enables decryption of an encrypted file. The access authentication method includes the steps of: receiving the decryption-key request; adding first authentication information which is used for authenticating the decryption-key request to the decryption-key request; transferring the decryption-key request; authenticating the decryption-key request on the basis of the first authentication information; and transmitting the decryption key upon successful authentication of the decryption-key request.

The summary of the present invention does not necessarily describe essential features of the present invention, and an arbitrary combination of the features described above is also encompassed by a scope of the present invention.

### BRIEF DESCRIPTION OF THE DRAWINGS

FIG. 1 is a schematic diagram of a principle of a first embodiment of the present invention;

FIG. 2 is a diagram illustrating an example of a processing-state management table stored in the state information storage of the client computer in the first embodiment of the present invention;

FIG. 3 is a diagram illustrating an example of location information in the first embodiment of the present invention;

FIG. 4 is a diagram illustrating an example of a processing-state management table stored in the state information storage of the network apparatus in the first embodiment of the present invention;

FIG. 5 is a diagram illustrating an example of a permission-information management table stored in the permission information storage in the first embodiment of the present invention;

FIG. 6 is a diagram illustrating an example of the frame format of a decryption-key request (at MAC level) in the first embodiment of the present invention;

FIG. 7 is a diagram illustrating an example of the frame format of a decryption-key request (at the IP layer) in the first embodiment of the present invention;

FIG. 8 is a diagram illustrating an example of the frame format of a decryption-key response (at the IP layer) in the first embodiment of the present invention;

FIG. 9 is a diagram illustrating an example of the frame format of a decryption-key response (at MAC level) in the first embodiment of the present invention;

FIG. 10 is a block diagram showing the hardware configuration of a computer that implements a client computer according to the first embodiment of the present invention; and

FIG. 11 is diagram illustrating an example of a processing flow of a file access authentication system according to the first embodiment of the present invention.

### DESCRIPTION OF THE PREFERRED EMBODIMENTS

### First Embodiment

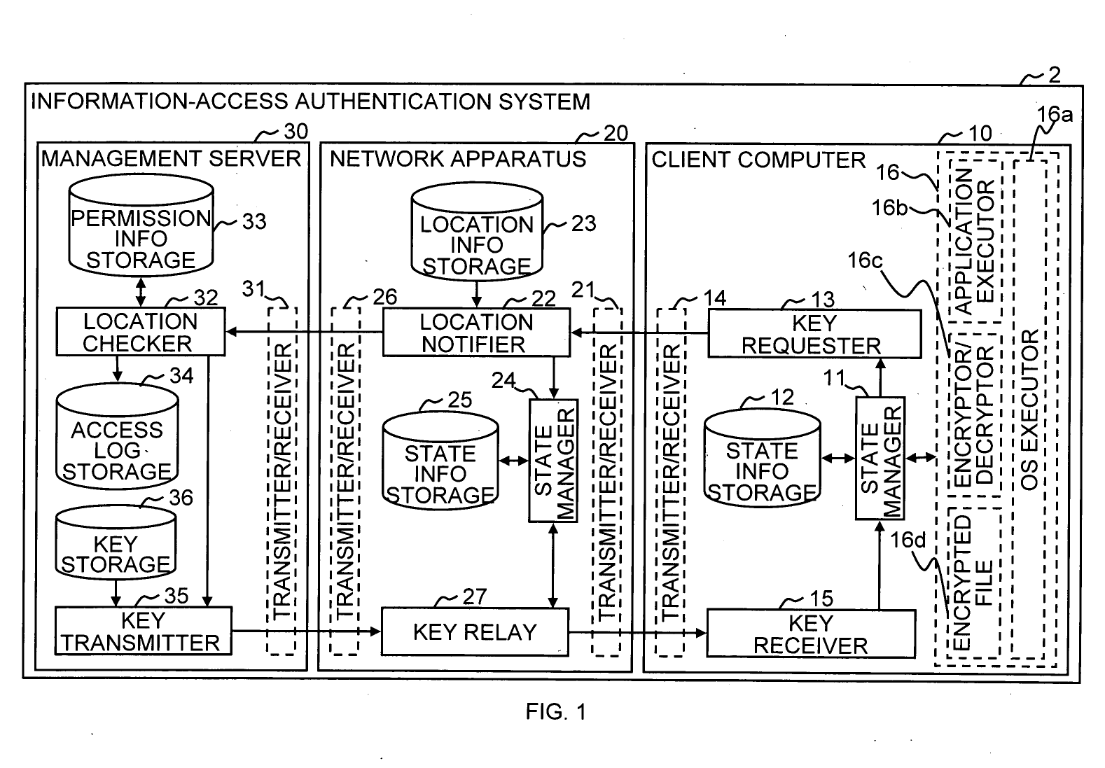

FIG. 1 is a schematic diagram of a principle of a first embodiment of the present invention. Referring to FIG. 1, a client computer 10 holds a file encrypted using a common-key cryptosystem and has a decryption agent including a key requester 13, a state manager 11, and a key receiver 15 installed thereon. A common key for decrypting the encrypted file 16d is pre-registered on a management server 30 and cannot be known by a user. Although an example using a common-key cryptosystem is described in the present embodiment, another cryptosystem can also be employed in the present invention as long as a decryption key can be used. For example, the present invention is also applicable to a case in which a public-key cryptosystem is employed, that is, secret information encrypted with a public key is decrypted with a secret key held by the management server 30.

The client computer 10 includes an OS (operating system) executor 16a, an application executor 16b, an encryptor/decryptor 16c, a state manager 11, a state information storage 12 (described as “STATE INFO STORAGE” in FIG. 1), a key requester 13, a transmitter/receiver 14, and a key receiver 15. The client computer 10 further has an encrypted file 16d to be decrypted. In FIG. 1, existing blocks are shown in dashed lines.

The application executor 16b handles (e.g., views, edits, and deletes) a file obtained by decrypting the encrypted file 16d.

The state manager 11 refers to and updates a processing-state management table stored in the state information storage 12 for managing the processing state of the client computer 10.

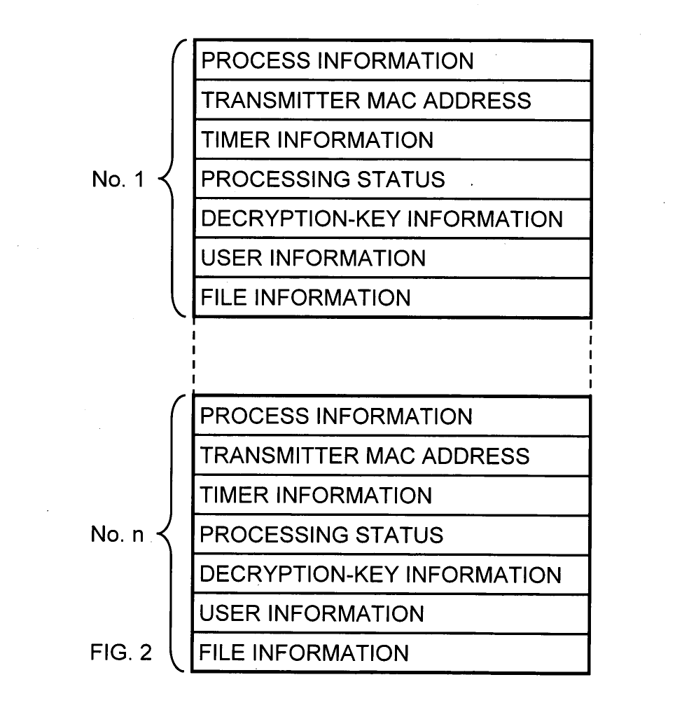

FIG. 2 is a diagram illustrating an example of a processing-state management table stored in the state information storage of the client computer in the first embodiment of the present invention. As shown in FIG. 2, the processing-state management table includes fields of Process Information serving as a process identifier of each encrypted file, Transmitter MAC Address, Timer Information indicating a remaining time until processing timeout, Processing Status indicating at least a status as to whether or not a decryption-key request is being processed, Decryption-Key Information, User Information such as a login user name, and File Information indicating an attribute of the encrypted file such as a folder path and a file name. For each decryption-key request, the state manager 11 creates an entry including the set of fields with values in each field. The arrangement may also be such that, instead of the Timer Information, time at which a decryption-key request is transmitted is recorded and a remaining time from the current time to the processing timeout is determined.

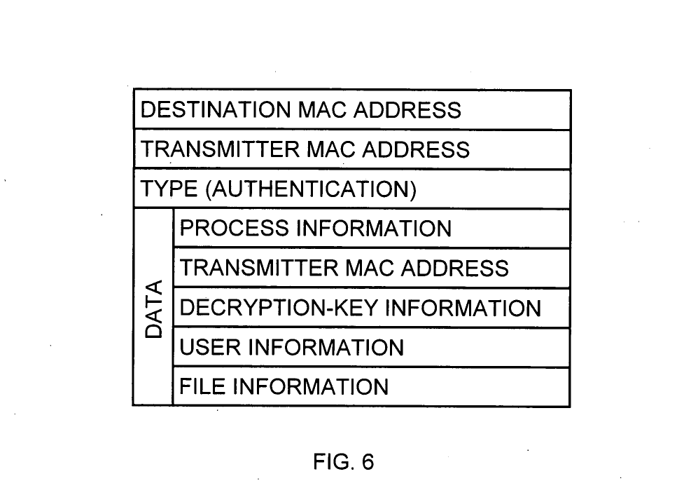

The key requester 13 requests for a decryption key for decrypting the encrypted file 16d to a network apparatus 20 via the transmitter/receiver 14. The key requester 13 creates a data portion of the decryption-key request (described in FIG. 6) transmitted from the client computer 10 to the network apparatus 20. The User Information and the File Information are not used in the present embodiment, and are used in second and third embodiments described below. In the present embodiment, however, values may be contained in the User Information and the File Information, in which case, the management server 30 can store a decryption key for each of the User Information and the File Information and transmit a corresponding decryption key to the client computer 10 on the basis of the User Information and the File Information corresponding to a decryption-key request. Such an arrangement can establish a high level of security due to the decryption key for each of the User Information and the File Information.

The transmitter/receiver 14 transmits data from the client computer 10 to a specified transmission destination and receives data transmitted from a transmission source other than the client computer 10 to the client computer 10. A LAN interface serves as an interface for connection with a network. As shown in FIG. 6, the client computer 10 transmits decryption-key request at MAC level. The destination address of the decryption-key request, in which the Type field contains a value indicating “authentication”, to the network apparatus 20 is a broadcast address. In this case, the network apparatus 20 can receive only a broadcast message from the client computer 10 that is located within the broadcast domain of the network apparatus 20.

The key receiver 15 receives the decryption key from the network apparatus 20 via the transmitter/receiver 14.

The encryptor/decryptor 16c decrypts the encrypted file 16d with a decryption key of the common-key cryptosystem and encrypts a file with an encryption key of the common-key cryptosystem. In the common-key cryptosystem, encryption and decryption are performed with the same common key.

The network apparatus 20 includes a transmitter/receiver 21, a location notifier 22, a location information storage 23 (described as “LOCATION INFO STORAGE” in FIG. 1), a state manager 24, a state information storage 25 (described as “STATE INFO STORAGE” in FIG. 1), a transmitter/receiver 26, and a key relay 27.

The transmitter/receiver 21 receives data from the client computer 10 directly (i.e., through a LAN cable connecting a network interface of the client computer 10 and a port of the network apparatus 20) or indirectly (i.e., via at least one network device, e.g., a repeater, a repeater hub, a bridge, and/or a switching hub, interposed between the client computer 10 and the network apparatus 20). The transmitter/receiver 21 also transmits data to the client computer 10 directly or indirectly.

The location notifier 22 adds specific location information stored in the location information storage 23 to a decryption-key request and transmits the decryption-key request to the management server 30.

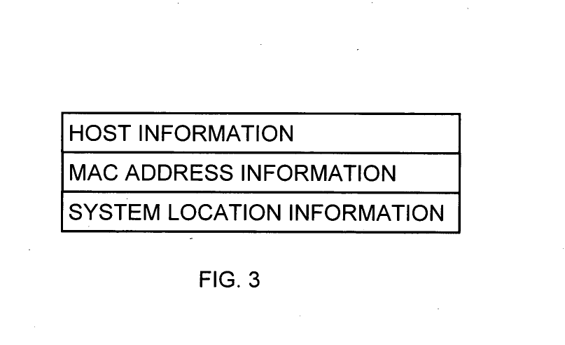

FIG. 3 is a diagram illustrating an example of location information in the first embodiment of the present invention. The location information includes Host Information of the network apparatus 20, MAC Address Information of the network apparatus 20, and System Location Information of the network apparatus 20. The System Location Information of the network apparatus 20 is set by a network administrator and may be, for example, “2nd floor in the main building”.

The state manager 24 refers to and updates a processing-state management table stored in the state information storage 25 for managing the processing state of the network apparatus 20.

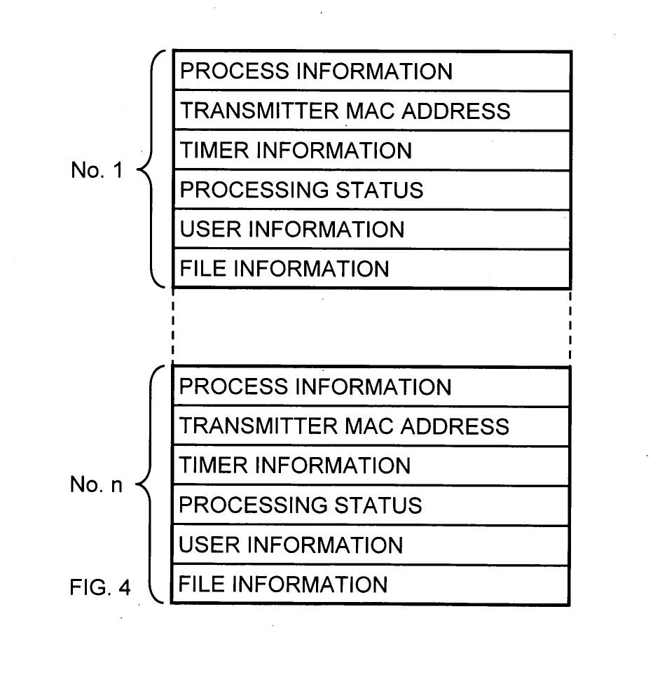

FIG. 4 is a diagram illustrating an example of a processing-state management table stored in the state information storage of the network apparatus in the first embodiment of the present invention. As shown in FIG. 4, the processing-state management table includes fields analogous to those in the processing-state management table stored in the state information storage of the client computer, except for the field of the Decryption-Key Information. For each decryption-key request, the state manager 24 creates an entry including the set of fields with values in each field.

The transmitter/receiver 26 transmits data to the management server 30 directly or indirectly and receives data from the management server 30 directly or indirectly.

The key relay 27 relays the decryption key received from the management server 30 to the client computer 10.

In the present embodiment, the network apparatus 20 is specifically an L2 (Layer 2: data link layer) switch (hub), which communicates with the client computer 10 at MAC level and communicates with the management server 30 at the IP (Internet Protocol) layer, e.g., using an SNMP (simple network management protocol).

The management server 30 includes a transmitter/receiver 31, a location checker 32, a permission information storage 33 (described as “PERMISSION INFO STORAGE” in FIG. 1), an access log storage 34, a key transmitter 35, and a key storage 36.

The transmitter/receiver 31 transmits data from the management server 30 to a specified transmission destination and receives data transmitted from a transmission source other than the management server 30 to the management server 30.

The location checker 32 extracts the location information of the decryption-key request received via the transmitter/receiver 31, compares the location information with location information stored in the permission information storage 33, and permits transmission of a decryption key when the two pieces of the location information are the same.

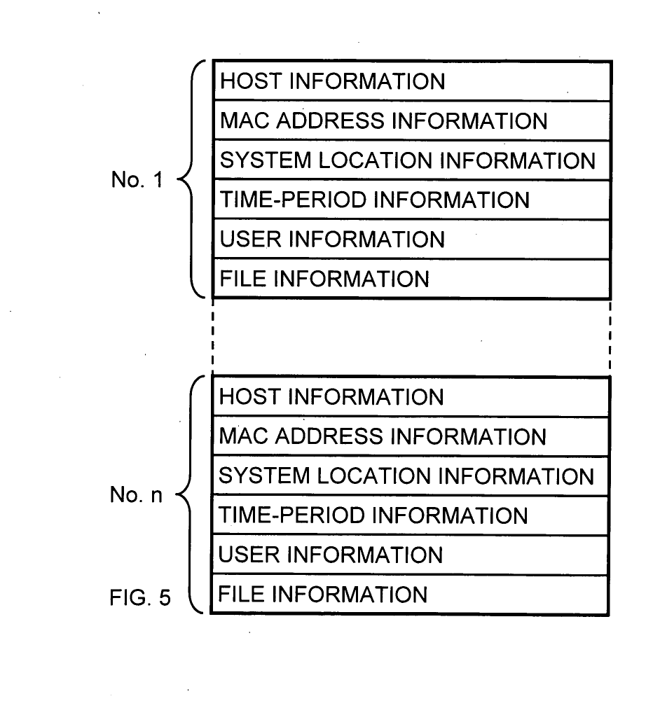

FIG. 5 is a diagram illustrating an example of a permission-information management table stored in the permission information storage in the first embodiment of the present invention. As shown in FIG. 5, the permission-information management table includes fields of Host Information of the network apparatus 20, MAC Address Information of the network apparatus 20, System Location Information of the network apparatus 20, Time-Period Information such as accessible-time information, User Information such as a login user name, and File Information indicating an attribute of the encrypted file such as a folder path and a file name. For each network apparatus 20, the set of fields are prepared, with values in each field. Since the User Information, the File Information, and the Time-Period Information are not used in the present embodiment, it is not necessary to store values thereof in the present embodiment. The User Information, the File Information, and the Time-Period Information are used in second, third, and fourth embodiments described below, respectively.

The access log storage 34 records the result of the comparison performed by the location checker 32. For example, the access log storage 34 records identification information (a Transmitter IP Address) of the network apparatus 20, Process Information, a Transmitter MAC Address, a comparison result (OK or not OK), and the time of the comparison result.

The key transmitter 35 receives a permission of decryption-key transmission from the location checker 32, reads a decryption key stored in the key storage 36, and transmits the decryption key to the network apparatus 20 via the transmitter/receiver 31.

FIG. 6 is a diagram illustrating an example of the frame format of a decryption-key request (at MAC level) in the first embodiment of the present invention. As shown in FIG. 6, the decryption-key request transmitted from the client computer 10 to the network apparatus 20 includes fields of Destination MAC Address (a broadcast address), Transmitter MAC Address (a MAC address of the client computer), and Type (with a value indicating “authentication”). As the Type field of the decryption-key request contains a value indicating “authentication”, the network apparatus 20 can treat the decryption-key request in a distinguished manner from other messages. That is, the network apparatus 20 applies a newly added means according to the present embodiment in treating the decryption-key request, and treats other messages with existing means of a typical network apparatus. The decryption-key request further includes a data portion. The data portion includes fields of Process Information, Transmitter MAC Address (a MAC address of the client computer), Decryption-Key Information (with a value of null), User Information, and File Information.

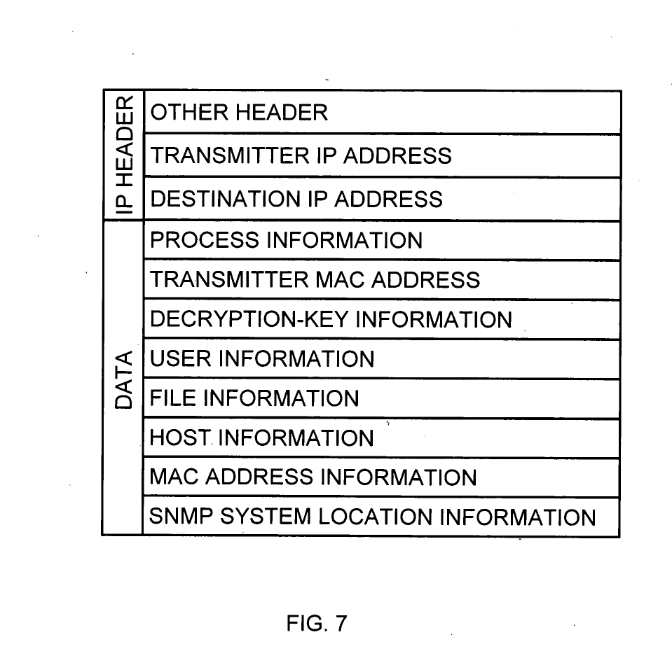

FIG. 7 is a diagram illustrating an example of the frame format of a decryption-key request (at the IP layer) in the first embodiment of the present invention. As shown in FIG. 7, the decryption-key request transmitted from the network apparatus 20 to the management server 30 includes an IP header portion and a data portion. The IP header portion includes Transmitter IP Address (an IP address of the network apparatus 20) and Destination IP address (an IP address of the management server 30). The data portion includes fields of Process Information, Transmitter MAC Address, Decryption-Key Information, User Information, File Information, Host Information, MAC Address Information, and SNMP System Location Information. The Process Information, the Transmitter MAC Address, the Decryption-Key Information, the User Information, and the File Information has the same values as those in the fields of the decryption-key request transmitted from the client computer 10 to the network apparatus 20. The Host Information, the MAC Address Information, and the SNMP System Location Information are added by the location notifier 22 in the network apparatus 20 on the basis of the location information stored in the location information storage 23. It is assumed that the management-server IP address contained in the Destination IP address is preset at the network apparatus 20. The arrangement may also be such that the setting of IP addresses of multiple management servers 30 is allowed and the decryption-key request is transmitted to one of the management servers 30. In addition, the arrangement may be such that the decryption-key request is transmitted to another management server 30 every time the timeout, which is described below, is reached.

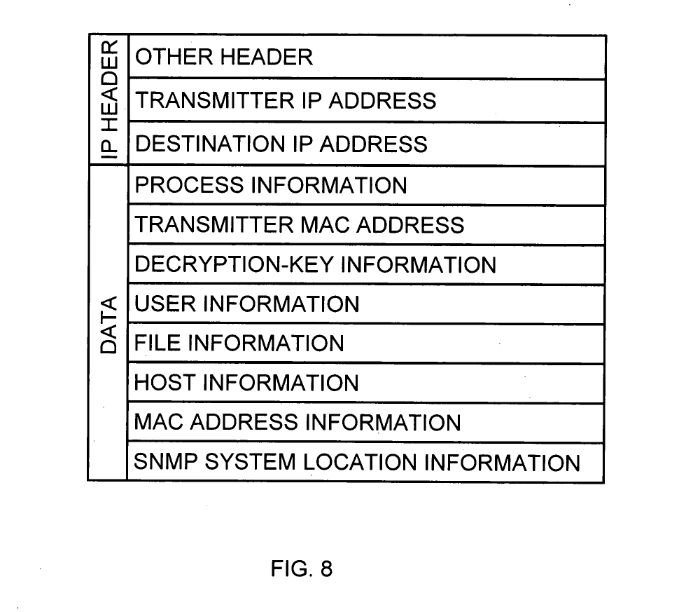

FIG. 8 is a diagram illustrating an example of the frame format of a decryption-key response (at the IP layer) in the first embodiment of the present invention. As shown in FIG. 8, the decryption-key response transmitted from the management server 30 to the network apparatus 20 includes fields analogous to those in FIG. 7, but different values from those in FIG. 7 are contained in the fields of the Transmitter IP Address (the management server 30), the Destination IP address (the network apparatus 20), and the Decryption-Key Information (actual decryption key is contained instead of “null”). Values contained in other fields are the same as those in FIG. 7. Thus, the management server 30 copies the decryption-key request received from the network apparatus 20 and stores values in necessary fields.

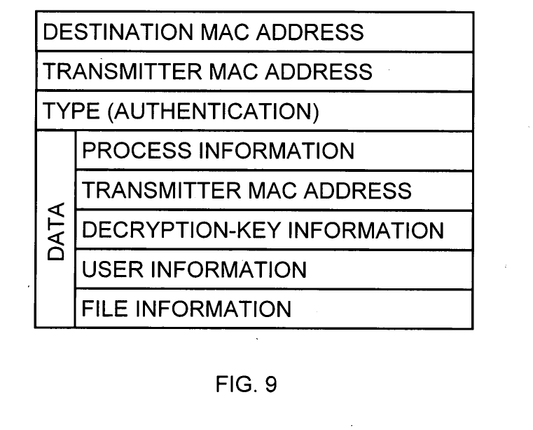

FIG. 9 is a diagram illustrating an example of the frame format of a decryption-key response (at MAC level) in the first embodiment of the present invention. As shown in FIG. 9, the decryption-key response transmitted from the network apparatus 20 to the client computer 10 includes fields analogous to those in FIG. 6, but different values from those in FIG. 6 are contained in the fields of the Destination MAC Address (the client computer 10), the Transmitter MAC Address (the network apparatus 20), and the Decryption-Key Information (actual decryption key is contained instead of “null”). Values contained in other fields are the same as those in FIG. 6. Thus, the network apparatus 20 copies the decryption-key request received from the client computer 10 and stores values in necessary fields.

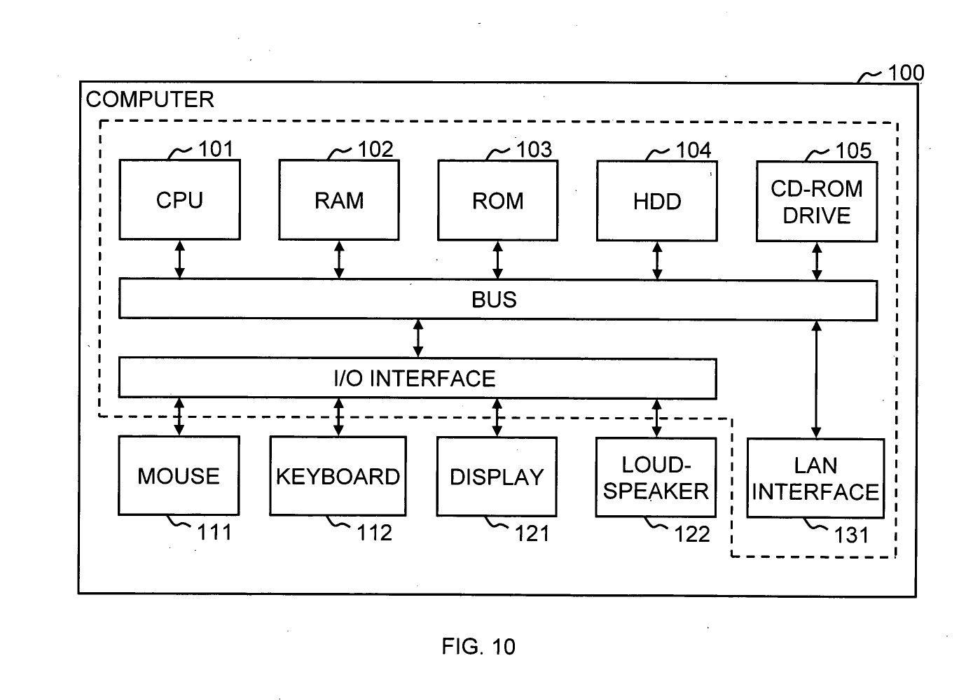

FIG. 10 is a block diagram showing the hardware configuration of a computer that implements a client computer according to the first embodiment of the present invention.

A computer 100 that implements the client computer 10 in the file access authentication system includes a CPU (central processing unit) 101, a RAM (random access memory) 102, a ROM (read only memory) 103, an HDD (hard disk drive) 104 which is an external storage device, a CD-ROM (compact disc read only memory) drive 105 for reading data from a CD-ROM, a mouse 111 and a keyboard 112 which are input devices, a display 121 and a loudspeaker 122 which are output devices, and a LAN interface 131 for connection with a network.

When a decryption agent program recorded on the external storage medium such as a CD-ROM is installed on the computer 100, i.e., the program is copied to the HDD 104 of the computer 100 so as to allow the program to be read and executed, the client computer 10 for the file access authentication system can be implemented by the computer 100.

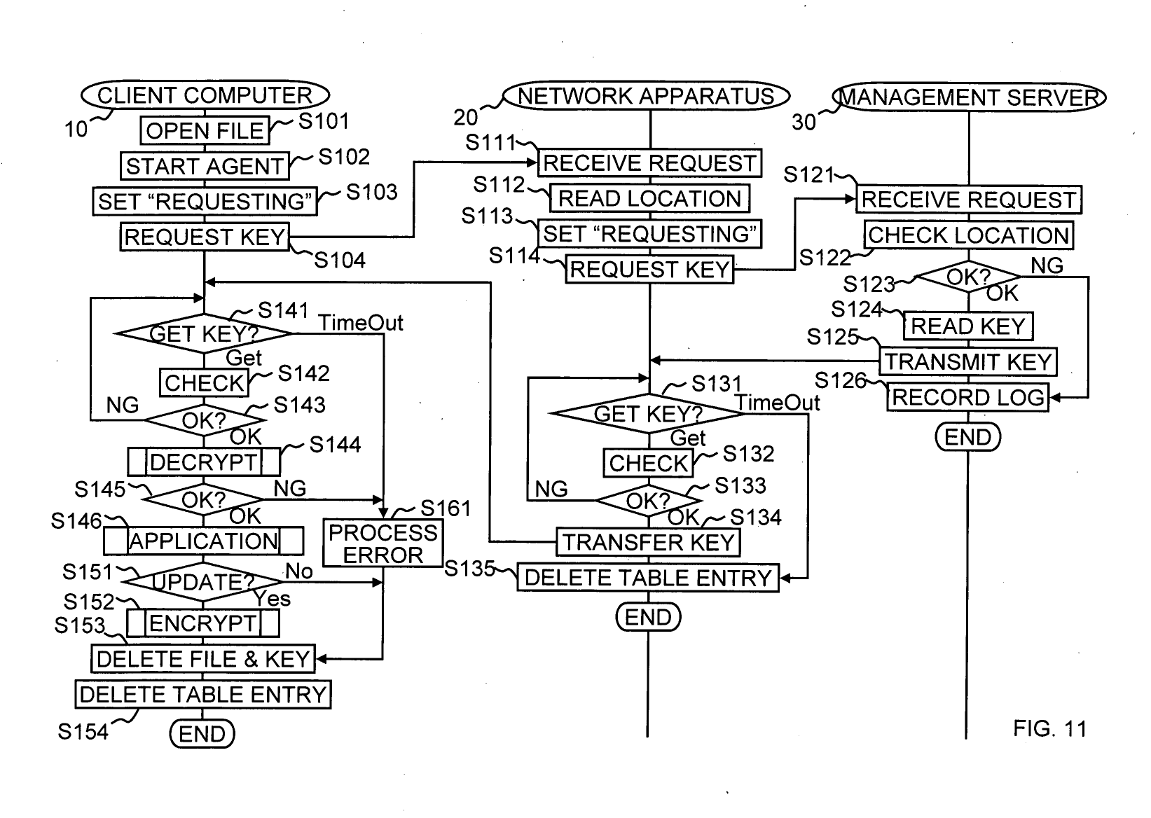

FIG. 11 is diagram illustrating an example of a processing flow of a file access authentication system according to the first embodiment of the present invention. The operation of the file access authentication system according to the present embodiment will now be described with reference to FIG. 11.

(Step S101) At the client computer 10, the user double-clicks an encrypted file which is associated with the decryption agent by using an OS function, such as association by file extension.

(Step S102) The associated decryption agent is initiated with the encrypted file as an argument. In the present embodiment, the decryption agent is triggered by the user access for the encrypted file. However, the decryption agent may be resident on the client computer 10.

(Step S103) The state manager 11 manages the encrypted file. The state manager 11 sets the Processing Status in the processing-state management table (FIG. 2) stored in the state information storage 12 to “the request being processed”.

(Step S104) The key requester 13 transmits a request for a decryption key for decoding the encrypted file to the network apparatus 20, such as a switching hub. In this case, the transmitter/receiver 14 is used to perform communication through the network. The communication is performed using an existing technology based on IEEE (Institute of Electrical and Electronics Engineers) 802.3 and the above-described new frame format (FIG. 6) based on MAC (L2) is used as the protocol for decryption-key request.

(Step S111) The location notifier 22 in the network apparatus 20 receives the decryption-key request via the transmitter/receiver 21.

(Step S112) The location notifier 22 reads its own location information (FIG. 3), such as the host name, the MAC address, and the location information for SNMP, stored in the location information storage 23, and adds the read information to the decryption-key request. It is not essential to add all of the illustrated information, i.e., the host name, the MAC Address Information, and the location information for SNMP.

(Step S113) The state manager 24 sets the Processing Status in the processing-state management table (FIG. 4) stored in the state information storage 25 to “the request being processed”.

(Step S114) The transmitter/receiver 26 transmits the decryption-key request to the management server 30. In this case, the above-described frame format (FIG. 7) based on the TCP (Transmission Control Protocol)/IP protocol is used for the decryption-key request.

(Step S121) The location checker 32 in the management server 30 receives the decryption-key request via the transmitter/receiver 31.

(Step S122) The location checker 32 checks the permission-information management table (FIG. 5) stored in the permission information storage 33 to determine whether or not the location information as been registered.

(Step S123) The result of the checking is evaluated. When the location information has not been registered, the process proceeds to step S126.

(Step S124) When the location information has been registered, the key transmitter 35 extracts a decryption key for decrypting the encrypted file that is pre-stored in the key storage 36.

(Step S125) The key transmitter 35 transmits a decryption-key response including the decryption key to the network apparatus 20 via the transmitter/receiver 31. In this case, the above-described frame format (FIG. 8) based on the TCP/IP protocol is used for the decryption-key response.

(Step S126) Information of the decryption-key request, the date and time of the request, and so on, together with information indicating a success or a failure, are recorded in the access log storage 34. The process on the management server 30 ends for the present decryption-key request.

(Step S131) After transmitting the decryption-key request in step S114, the network apparatus 20 is waiting for a decryption-key response. When a timeout of the state occurs (Step S131: TimeOut), the process proceeds to step S135.

(Step S132) When the network apparatus 20 receives the decryption-key response via the transmitter/receiver 26, the state manager 24 checks the processing-state management table (FIG. 4) stored in the state information storage 25 to determine whether or not the decryption-key request corresponding to the present decryption-key response is being processed.

(Step S133) The result of the checking is evaluated. Since the processing-state management table contains multiple entries, the corresponding decryption-key request must be identified. This is performed by, for example, uniquely identifying an entry on the basis of the Transmitter MAC Address and the Process Information in the decryption-key response. When the corresponding decryption-key request is not being processed (step S133: NG), the decryption-key response is ignored and the process returns to step S131 to wait another decryption-key response.

(Step S134) When the corresponding decryption-key request is being processed (step S133: OK), the key relay 27 generates a decryption-key response in the new frame format (FIG. 9) based on MAC (L2) which contains the decryption key and transmits the decryption-key response to the client computer 10 via the transmitter/receiver 21.

(Step S135) The state manager 24 deletes a corresponding entry for the present decryption-key request from the processing-state management table (FIG. 4) stored in the state information storage 25. The process on the network apparatus 20 ends for the present decryption-key request.

(Step S141) After the client computer 10 transmits the decryption-key request in step S104, the client computer 10 is waiting for a decryption-key response. When a timeout of the state occurs (Step S141: TimeOut), the process proceeds to step S161.

(Step S142) When the key receiver 15 receives the decryption-key response via the transmitter/receiver 14, the state manager 11 checks the processing-state management table (FIG. 2) stored in the state information storage 12 to determine whether or not the decryption-key request corresponding to the present decryption-key response is being processed.

(Step S143) The result of the checking is evaluated. Since the processing-state management table contains multiple entries, the corresponding decryption-key request must be identified. This is performed by, for example, uniquely identifying an entry on the basis of the Transmitter MAC Address and the Process Information in the decryption-key response. When the corresponding decryption-key request is not being processed (step S143: NG), the decryption-key response is ignored and the process returns to step S141 to wait another decryption-key response.

(Step S144) When the corresponding decryption-key request is being processed (step S143: OK), the encryptor/decryptor 16c decrypts the encrypted file with the decryption key into a temporary file.

(Step S145) The result of the decryption is evaluated. When the decryption processing failed (step S145: NG), the process proceeds to step S161.

(Step S146) When the decryption processing succeeded (step S145: OK), a corresponding application executor 16b is started with the decrypted temporary file as an argument. In this case, through the use of association by file extension, multiple applications can be started by changing the extension for the corresponding type of application or pre-registering the relationship between files and applications.

The decryption processing is accomplished and the application processing is started using existing technologies. Instead of decrypting the encrypted file into a temporary file as in the present embodiment, encryption/decryption processing may be performed at an I/O (input/output) portion to a physical file in such a manner as incorporated in a file system of the OS. An example is that an encryption/decryption chip for performing encryption/decryption with a key is provided between the HDD and the main memory installed on the motherboard, i.e., at an ATA (advanced technology attachment) interface, a bridge, or a bus, and only when a decryption key is passed to the chip, the encrypted file is decrypted and loaded in the main memory. The decryption agent may be directly started without the association by file extension. In this case, it is necessary to perform a series of process in a lump from generation of a temporary file to its deletion.

(Step S151) When the application executor 16b ends the process, it is checked whether or not the temporary file is updated. When the temporary file is not updated (step S151: No), the process proceeds to step S153.

(Step S152) When the temporary file is updated (step S151: Yes), the encryptor/decryptor 16c encrypts the temporary file with the decryption key into another encrypted file. The encrypted file is then updated.

(Step S153) The temporary file and the decryption key (if exit) are deleted.

(Step S154) The state manager 11 deletes a corresponding entry for the present decryption-key request from the processing-state management table (FIG. 2) stored in the state information storage 12. The process on the client computer 10 ends for the present decryption-key request.

(Step S161) Error processing, such as displaying an error message on the display, is performed.

In the present invention, as described above, when the decryption-key request transmitted from the client computer is transferred to the management server via the network apparatus, the network apparatus, instead of the client computer, adds location information to the decryption-key request. When the decryption-key request reaches the management server, the location information associated with the decryption-key request is compared with location information stored therein. When the two pieces of the location information are the same, the decryption key is transmitted to the client computer. Thus, only when the management server receives the decryption-key request via the network apparatus which adds the specific location information to the decryption-key request, the management server transmits the decryption key to the client computer. Therefore, even when the management server processes a decryption-key request without going through the network apparatus, the client computer cannot receive the decryption key, thus providing an advantage in that accessing encrypted file can be restricted to within a specific area.

### Second Embodiment

In the first embodiment, the arrangement may be such that User Information is added to the decryption-key requests (FIGS. 6 and 7) and the decryption-key responses (FIGS. 8 and 9). The location checker 32 in the management server 30 performs the checking (step S122), and the determination (step S123) in conjunction with the User Information and the location information contained in the permission-information management table (FIG. 5) stored in the permission information storage 33. With this arrangement, the access right can be changed for each user. Thus, even in a case in which the location information associated with the decryption-key request is the same as the location information contained in the permission-information management table (FIG. 5) stored in the permission information storage 33, when User Information associated with the decryption-key request does not exist or it is different from the User Information stored in the permission information storage 33, the management server 30 does not transmit the decryption key. In this case, as the User Information, the client computer 10 may use user information and/or login information which is registered in the OS, such as the Windows® OS, or may use user information specified (or set) for the decryption agent.

The User Information may also be added to the processing-state management table (FIG. 2) stored in the state information storage 12 in the client computer 10 and the processing-state management table (FIG. 4) stored in the state information storage 25 in the network apparatus 20. With this arrangement, checking the processing-state management table containing the User Information allows the access to be restricted for each user.

In the present embodiment, as described above, the client computer may include user information in the decryption-key request. In such a configuration, the management server compares both location information and user information and transmits the decryption key to the client computer when the corresponding pieces of the information are the same. Thus, there is an advantage in that access to encrypted file can be controlled for each user. When the management server stores a decryption key for each piece of user information and receives a decryption-key request including the user information, the management server may transmit the decryption key corresponding to the user information to the client computer.

### Third Embodiment

In the first embodiment, the arrangement may be such that File Information is added to the decryption-key requests (FIGS. 6 and 7) and the decryption-key responses (FIGS. 8 and 9). The location checker 32 in the management server 30 performs the checking (step S122), and the determination (step S123) in conjunction with the File Information and the location information contained in the permission-information management table (FIG. 5) stored in the permission information storage 33. With this arrangement, the access right can be changed for each file. Thus, even in a case in which the location information associated with the decryption-key request is the same as the location information contained in the permission-information management table (FIG. 5) stored in the permission information storage 33, when File Information associated with the decryption-key request does not exist or it is different from the File Information stored in the permission information storage 33, the management server 30 does not transmit the decryption key.

The File Information may also be added to the processing-state management table (FIG. 2) stored in the state information storage 12 in the client computer 10 and the processing-state management table (FIG. 4) stored in the state information storage 25 in the network apparatus 20. With this arrangement, checking the processing-state management table containing the File Information allows the access to be restricted for each file.

In the present embodiment, as described above, the client computer may include attribute information of the encrypted file in the decryption-key request. In such a configuration, the management server compares both location information and the attribute information, and transmits the decryption key to the client computer when the corresponding pieces of the information are the same. Thus, there is an advantage in that access to encrypted file can be controlled for each piece of attribute information of the encrypted file. When the management server stores a decryption key for each piece of attribute information of the encrypted file and receives a decryption-key request including the attribute information of the encrypted file, the management server may transmit the decryption key corresponding to the attribute information of the encrypted file to the client computer.

The attribute information of the encrypted file may include a file name, a file size, file creation date, file update date, file print date, and so on.

### Fourth Embodiment

In the first embodiment, the arrangement may be such that the location checker 32 in the management server 30 checks the location information contained in the permission-information management table (FIG. 5) stored in the permission information storage 33 and also checks whether or not the current time is within the time period pre-registered in he permission-information management table (FIG. 5) stored in the permission information storage 33. With this arrangement, the time at which the decryption key is transmitted can be restricted. Thus, even in a case in which the location information associated with the decryption-key request is the same as the location information stored in the permission information storage 33, when the current time is not within the time period stored in the permission information storage 33, the management server 30 does not transmit the decryption key.

In the present embodiment, as described above, when the decryption-key request transmitted from the client computer to the management server is received in a predetermined time period, the decryption key is transmitted to the client computer, whereas when the decryption-key request transmitted from the client computer to the management server is received at time other than the predetermined time period, the decryption key is not transmitted to the client computer. Thus, access to encrypted file can be controlled in a predetermined time period.

The reception time period of the decryption-key request can be varied for each piece of attribute information of the encrypted file. For example, person A can obtain a decryption key from 8:00 to 12:00 and person B can obtain a decryption key from 13:00 to 18:00.

### Other Embodiments

In the configuration in the first embodiment, when a decryption-key request containing the MAC address of the client computer 10 in its data portion is transmitted to the management server 30 via the network apparatus 20, the management server 30 transmits a decryption-key response containing the MAC address of the client computer 10 in its data portion to the network apparatus 20, and then the network apparatus 20 transmits the decryption-key response to the client computer 10. The transmission to the client computer 10 is performed using the MAC address of the client computer 10 which is contained in the data portion of the decryption-key response received from the management server 30. Thus, even when the network apparatus 20 does not hold a decryption-key request received from the client computer 10, the network apparatus 20 can transmit the decryption-key request received from the management server 30 to the client computer 10.

This is also applicable to a case in which, when the decryption-key request received from the client computer 10 does not contain the MAC address of the client computer 10 in its data portion and the network apparatus 20 obtains the MAC address of the client computer 10 from the header portion of the decryption-key request and stores the obtained MAC address in the data portion of the decryption-key request transmitted to the management server 30.

When a configuration in which the MAC address of the client computer 10 is not contained in the decryption-key request transmitted to the management server 30 is employed, the arrangement may be such that the MAC address of the client computer 10 which is contained in the header portion of the decryption-key request received from the client computer 10 is recorded together with information (the Process Information, the Transmitter IP Address, the File Information, the User Information, or a combination thereof) that allows the network apparatus 20 to identify a decryption-key response, the information that can identify the decryption-key response is contained in the data portion of the decryption-key request transmitted to the management server 30 and is also contained in the data portion of the decryption-key response received from the management server 30, the network apparatus 20 obtains the MAC address of the corresponding client computer 10 on the basis of the information that can identify the decryption-key response, and the decryption-key response is transmitted to the client computer 10.

Communication between the client computer and the network apparatus is preferably performed at the data link layer and the decryption-key request transmitted from the client computer to the network apparatus has a broadcast address as its destination address.

More specifically, the client computer and the network apparatus communicate with each other through, for example, Ethernet®, that is, a LAN (local area network) in which MAC (media access control) based on a carrier sense multiple access/collision detection (CSMA/CD) system is performed, and the destination address of the decryption-key request transmitted from the client computer to the network apparatus is “FF:FF:FF:FF:FF:FF”.

With this arrangement, when the network apparatus is located in a broadcast domain that includes a repeater or repeater hub for relaying a broadcast message, a bridge, and a switching hub, the client computer can obtain the decryption key transmitted from the management server via the network apparatus only when the client computer exists in the broadcast domain.

In each embodiment described above, the decryption-key request is transmitted from the client computer 10 to the management server 30 via the network apparatus 20, and the decryption-key response is transmitted from the management server 30 to the client computer 10 via the network apparatus 20. However, the arrangement may be such that the management server 30 directly transmits the decryption-key response to the client computer 10 by using the Transmitter MAC Address in the data portion of the decryption-key request. In such configuration, corresponding entry in the processing-state management table stored in the state information storage 25 of the network apparatus 20 is deleted when the timeout is reached.

The technical scope of the present invention is not limited to the embodiments described above and various changes or improvements can be made thereto. It is obvious from the appended claims and summary of the invention that the embodiments to which such changes or improvements are made are also encompassed by the technical scope of the present invention.

The present invention can be implemented not only as a system but also as a method or a program storing medium storing program thereof.

What is claimed is:

1. An access authentication system comprising:
a client computer for transmitting a decryption-key request requesting for a decryption key which enables decryption of an encrypted file;
a network apparatus for adding to the decryption-key request first authentication information for authenticating the decryption-key request, and transferring the decryption-key request; and
a management server for authenticating the decryption-key request on the basis of the first authentication information, and transmitting the decryption key to the client computer upon successful authentication of the decryption-key request.

2. The access authentication system of claim 1,
said first authentication information including location information indicating a location of the network apparatus.

3. The access authentication system of claim 1,
said client computer adding second authentication information for authenticating the decryption-key request to the decryption-key request,
said management server authenticating the decryption-key request on the basis of the first authentication information and the second authentication information.

4. The access authentication system of claim 3,
said second authentication information including user information indicating a user of the client computer.

5. The access authentication system of claim 3,
said second authentication information including attribute information indicating an attribute of the encrypted file.

6. The access authentication system of claim 1,
said management server authenticating the decryption-key request on the basis of the first authentication information and a time of receiving the decryption-key request.

7. The access authentication system of claim 1,
said client computer communicating with the network apparatus at a data link layer and transmitting the decryption-key request with a broadcast address as a destination address thereof.

8. An access authentication method executed by an access authentication system including a network apparatus, said access authentication system authenticating a decryption-key request transmitted from a client computer, said decryption-key request requesting for a decryption key which enables decryption of an encrypted file, said access authentication method comprising the steps of:
receiving the decryption-key request;
adding to the decryption-key request first authentication information for authenticating the decryption-key request;
transferring the decryption-key request;
authenticating the decryption-key request on the basis of the first authentication information; and
transmitting the decryption key upon successful authentication of the decryption-key request.

9. The access authentication method of claim 8,
said first authentication information including location information indicating a location of the network apparatus.

10. The access authentication method of claim 8,
said decryption-key request including second authentication information for authenticating the decryption-key request,
the decryption-key request being authenticated, in said authenticating step, on the basis of the first authentication information and the second authentication information.

11. The access authentication method of claim 10,
said second authentication information including user information indicating a user of the client computer.

12. The access authentication method of claim 10,
said second authentication information including attribute information indicating an attribute of the encrypted file.

13. The access authentication method of claim 8,
the decryption-key request being authenticated, in said authenticating step, on the basis of the first authentication information and a time of receiving the decryption-key request.

14. A program storage medium readable by a computer, said program storage medium storing programs of instructions for a first computer and a second computer for executing an access authentication method, said first computer authenticating a decryption-key request transmitted from a client computer, said decryption-key request requesting for a decryption key which enables decryption of an encrypted file, said access authentication method comprising the steps of:
receiving the decryption-key request;
adding to the decryption-key request first authentication information for authenticating the decryption-key request;
transferring the decryption-key request;
authenticating the decryption-key request on the basis of the first authentication information; and
transmitting the decryption key upon successful authentication of the decryption-key request.

15. The program storage medium of claim 14,
said first authentication information including location information indicating a location of the second computer.

16. The program storage medium of claim 14,
said decryption-key request including second authentication information for authenticating the decryption-key request,
the decryption-key request being authenticated, in said authenticating step, on the basis of the first authentication information and the second authentication information.

17. The program storage medium of claim 16,
said second authentication information including user information indicating a user of the client computer.

18. The program storage medium of claim 16,
said second authentication information including attribute information indicating an attribute of the encrypted file.

19. The program storage medium of claim 14,
the decryption-key request being authenticated, in said authenticating step, on the basis of the first authentication information and a time of receiving the decryption-key request.
